(19) United States
(12) Patent Application Publication
(10) Pub. No.: US 2026/0214127 A1
(43) Pub. Date: Jul. 23, 2026

(54) A SYSTEM AND METHOD FOR HANDLING NETWORK SLICE ADMISSION CONTROL

(71) Applicant: Samsung Electronics Co., Ltd., Suwon-si, Gyeonggi-do (KR)

(72) Inventors: Ashok Kumar NAYAK, Bangalore (IN); Lalith KUMAR, Bangalore (IN); Danish Ehsan HASHMI, Bangalore (IN)

(21) Appl. No.: 19/142,837

(22) PCT Filed: Dec. 27, 2023
(86) PCT No.: PCT/KR2023/021737

§ 371 Date: Jun. 24, 2025

(30) Foreign Application Priority Data
Dec. 28, 2022 (IN) 202241076335
Dec. 1, 2023 (IN) 202241076335

(51) Int. Cl. H04L 65/1069; H04L 41/082

(52) U.S. Cl. CPC H04L 65/1069; H04L 41/082

(57) ABSTRACT

The disclosure relates to a 5G or 6G communication system for supporting a higher data transmission rate. A method performed by a network slice admission control function (NSACF) in a communication system, the method comprising: receiving, from a session management function plus packet data network gateway control plane function (SMF+PGW−C), a message for controlling a number of user equipment (UEs) registered to a network slice, the message comprising an update flag; identifying whether the update flag comprises update value indicating that an access type of the UE is to be replaced with a new access type; and in case that the update flag comprises the update value, replacing the access type of the UE with the new access type.

### TECHNICAL FIELD

The present invention relates generally to a field of network slicing, and more particularly, to a system and a method of ensuring that Fifth Generation (5G) system is able to accurately enforce quota on maximum number of registered UEs and maximum number of concurrent sessions using a network slice defined by a Single Network Slice Selection Assistance Information (S-NSSAI).

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

Generally, network slicing allows telecom service providers to deploy an exclusive network for a customer (e.g., MVNO, Enterprise) or service (e.g., eMBB, URLLC, mMTC), consisting of multiple network functions designed specifically to support specialized service. This is introduced by 3rd Generation Partnership Project (3GPP) release 15. A set of such network slices are identified using Single Network Slice Selection Assistance Information (S-NSSAI) inside a 3GPP network. These slices are characterized by a set of both standard and proprietary attributes as defined by a “slice template.” GSMA defines a “Generic Network Slice Template” (GST) which provides standardized slice attributes for a set of services supported by 3GPP.

Two of the attributes defined by GST are “Number of Terminals” and “Number of Sessions.” The attribute “Number of Terminals” describes a maximum Number of Terminals (UEs) that can use the network slice simultaneously. Similarly, the attribute “Number of Sessions” describes a maximum number of Protocol Data Unit (PDU) sessions that can use the network slice simultaneously. These are important inputs in network planning, as operators need to make sure that resources, they provide for the network slice are sufficient to handle the capacity specified by these attributes.

To enforce these attributes, 3GPP Rel-17 defines a functional entity “Network Slice Admission Control Function (NSACF)” which monitors and controls the Number of UEs/sessions registered to a network slice. The NSACF is configured with the maximum Number of UEs per network slice and is expected to be consulted (by AMF) while admitting a UE to the network. Similarly, the NSACF is configured with the maximum Number of Sessions per network slice and is expected to be consulted by a network function such as SMF or SMF+PGW−C while activating a PDU Session. This is done for all network slices which are subject to a “quota” defined by these attributes or NSAC (Network Slice Admission Control). In 3GPP terminology, “Number of Terminals” may refer to “Number of UEs” or “Number of Registrations” per access-type. Similarly, the “Number of Sessions” may refer to “Number of PDU Sessions.” The terms are used interchangeably throughout the present disclosure.

As specified in 3GPP TS 23.501 and TS 23.502 in release 17, the NSACF controls (i.e., increases or decreases) a current Number of UEs registered for a network slice so that it does not exceed the maximum Number of UEs allowed to register with that network slice based on the request it receives from the AMF. The NSACF may count the number of registered UEs based on the access type information received from the AMF.

Similarly, the NSACF also controls (i.e., increase or decrease or updates) the current number of PDU sessions per network slice so that it does not exceed the maximum Number of Sessions allowed to be served by that network slice based on the request it receives from SMF.

The UE registration count is done whenever a UE registers over 5GC irrespective of any PDU session is established or not. But in Evolved Packet System (EPS), the UE registration count is performed only when UE initiates one packet data network (PDN) connection. So, the GSMA provides another requirement where UE registration count may be performed in 5GS when at least one PDU session may be established by the UE.

Further, the GSMA clarified that when EPS counting is required, two options are supported i.e., a first option and a second option. The first option is the maximum Number of UEs limit in 5GS which applies to the UEs which are registered in 5GS and so the restriction criterion is not uniform across EPS and 5GS as the UEs in the EPS are counted when they have at least one PDN Connection. The second option is the maximum Number of UEs limit applies to the UEs with at least one PDU session/one PDN connection, and so the restriction criterion is uniform across the EPS and the 5GS.

In order to allow the two options, an attribute “maximum Number of UEs with at least one PDU session/PDN connection” needs to be added. So, the first option applies when the “maximum Number of UEs” attribute with EPS counting enabled is in Network Slicing Task Force (NEST), while the second option applies to when “maximum Number of UEs with at least one PDU sessions/PDN connection” attribute is in the NEST.

The solution for the first option is present in TS 23.501 and TS 23.502 in Release 17.

It may be known that the network function such as SMF or SMF+PGW−C may count the number of registered UEs and inform the NSACF when the UE initiates the PDU session in 5G along with the existing procedure of performing concurrent PDU session counting procedure towards the NSACF.

It means that when UE initiates one PDU session in 5GS over 3GPP access type (AT), then the SMF may inform the NSACF to increase the number of UE registered count for the 3GPP AT. Similarly, if the UE initiates one PDU session in the 5GS over non-3GPP AT then the SMF may inform the NSACF to increase the number of UE registered count for the non-3GPP AT. During release of the PDU session, the SMF may inform to decrease the number of UE registered count accordingly.

If the PDU sessions are handled by different SMFs then each SMF may inform about increase or decrease whenever a PDU session is established or released. But the NSACF may count only one time for the number of registered UEs even if it receives from the multiple SMFs to increase the count during PDU establishment as it is the same UE. Similarly, it may not decrease the UE count until unless last PDU session is not released from the network even if it receives from the multiple SMFs to decrease the UE count during the PDU release.

Overall, the SMF may take the role of AMF from existing solution to count the number of registered UEs. The SMF may be SMF+PGW−C if the UE is in EPS and the PDN connection is triggered with the slice subject to NSAC or even if the UE is in 5GS and the PDU is triggered when the S-NSSAI is subjected to EPC IWK.

Thus, when a UE initiate one PDU session in 5GS over the 3GPP AT, then the SMF may inform the NSACF to increase the number of UE registered count for the 3GPP AT. Similarly, if the UE initiates one PDU session in 5GS over the non-3GPP AT, then the SMF may inform the NSACF to increase the number of UE registered count for the non-3GPP AT. During the release of the PDU session, the SMF may inform to decrease the number of UE registered count accordingly.

But there are some scenarios where the UE transfers a PDU session from the non-3GPP AT to the 3GPP AT via the use of the allowed PDU session status IE which is sent by the UE as part of the service request procedure when the UE either receives Radio Resource Control (RRC) paging message (on the 3GPP access) with an access type set to the non-3GPP AT, or when the UE receives a notification message on the 3GPP AT and the access type in Non-access stratum (NAS) message indicates non-3GPP AT.

Also, the UE transfers a PDU session from one access type to another access type using 5GSM signaling message. For example, the UE transfers the PDU session from the non-3GPP AT to the 3GPP AT by sending the PDU session establishment request message. Here, the UE needs to send a 5GSM message to achieve the transfer of the session to a target access type.

In these scenarios, the SMF needs to ensure that the UE registration count is decreased for the non-3GPP AT and is increased for the 3GPP AT (assuming in this case PDU Session is transferred from non-3GPP AT to 3GPP AT) which may not be possible using the existing mechanism.

The information disclosed in this background of the disclosure section is only for enhancement of understanding of the general background of the invention and should not be taken as an acknowledgement or any form of suggestion that this information forms the prior art already known to a person skilled in the art.

### DISCLOSURE OF INVENTION

### Technical Problem

In line with development of the communication systems, there is a need for method and apparatus for handling network slice admission control.

The technical subjects pursued in the disclosure may not be limited to the above mentioned technical subjects, and other technical subjects which are not mentioned may be clearly understood, through the following descriptions, by those skilled in the art to which the disclosure pertains.

### Solution to Problem

The present invention relates generally to network slicing in 3GPP, and more particularly, to a system and method of ensuring that 5G system is able to accurately enforce quota on the maximum number of registered UEs using a network slice. The methods disclosed herein describe how NSACF does the counting for the number of registered UEs when PDU session transfers takes place in the system with the new updated information received from network function.

One or more shortcomings discussed above are overcome, and additional advantages and features are provided by the present disclosure. Other embodiments and aspects of the disclosure are described in detail herein and are considered a part of the disclosure.

In a non-limiting embodiment of the present disclosure, a method of handling network slice admission control is disclosed. The method comprises receiving, at a network function, a session transfer request message from a user equipment (UE) for transferring a session from an old access type to a new access type. The method further comprise sending, by the network function, update request having an update attribute to a Network Slice Admission Control Function (NSACF) for informing the NSACF about the new access type of the UE to provide the network slice admission control for a maximum number of registered UEs with at least one session.

In another non-limiting embodiment of the present disclosure, the network function comprises one of a Session Management Function (SMF) and Session Management Function Plus Packet data Unit Gateway (SMF+PGW−C).

In another non-limiting embodiment of the present disclosure, the session comprises one of Protocol Data Unit (PDU) session and Packet Data Network (PDN) connection.

In another non-limiting embodiment of the present disclosure, the old access type and the new access type are selected from a group of: 3GPP access type and non-3GPP access type, wherein the old access type and the new access type are different.

In yet another non-limiting embodiment of the present disclosure, the update request is a Nnsacf_NSAC_NumOfUEsUpdate request.

In yet another non-limiting embodiment of the present disclosure, a method of handling network slice admission control is disclosed. The method includes receiving, at a Network Slice Admission Control Function (NSACF), update request from a network function, wherein the update request includes an update attribute with information pertaining to a new access type of a user equipment (UE) which is already in a session over an old access type. The method further includes replacing the old access type of the session with the new access type. Further, the method includes determining whether to update UE count for at least one of the old access type and the new access type based on the update request. The method further includes updating the UE count for the at least one of the old access type and the new access type based on the determining that the UE count needs to be updated for providing the network slice admission control.

In another non-limiting embodiment of the present disclosure, the network function comprises one of a Session Management Function (SMF) and Session Management Function Plus Packet data Unit Gateway (SMF+PGW−C).

In another non-limiting embodiment of the present disclosure, the session comprises one of PDU session and PDN connection.

In yet another non-limiting embodiment of the present disclosure, the update request is received from the network function in response to triggering of a transfer of the session from the old access type to the new access type.

In yet another non-limiting embodiment of the present disclosure, for determining whether to update the UE count for the at least one of the old access type and the new access type based on the update request, the method includes determining whether there is an UE entry available in both new access type and old access type with the NSACF.

In yet another non-limiting embodiment of the present disclosure, upon determining availability of UE entry in the old access type with only same or associated network function ID and unavailability of UE entry in the new access type, the method includes determining that the UE count for the at least one of the old access type and the new access type needs to be updated. The method also includes updating the UE count for the at least one of the old access type and the new access type by decreasing the UE count for the old access type, and removing the UE entry, and increasing the UE count for the new access type by creating an UE entry.

In yet another non-limiting embodiment of the present disclosure, upon determining availability of UE entry in the old access type with same or associated network function (NF) ID (i.e. matching network function from which the request is received) along with other network function, the method includes determining that the UE count for the at least one of the old access type and the new access type needs to be updated, and updating the UE count for the old access type by keeping the UE count for the old access type unchanged and remove associated network function ID.

In yet another non-limiting embodiment of the present disclosure, upon determining availability of UE entry in the new access type with other network function (NF) IDs, the method includes determining that the UE count for the at least one of the old access type and the new access type needs to be updated. The method also includes updating the UE count for the new access type by keeping the UE count for the new access type unchanged and adding the associated network function ID.

In yet another non-limiting embodiment of the present disclosure, upon determining that availability of UE entry in both old access type and new access type, the method includes determining that the UE count needs to be kept unchanged for both the new access type and old access type, and keeping the UE count for both the new access type and old access type unchanged and deleting associated network function ID from old access type and adding associated network function ID in the new access type.

In yet another non-limiting embodiment of the present disclosure, upon determining that the other session over the new access type in association with the other network function is available and the other session over the new access type is unavailable, the method includes determining that the UE count for the at least one of the old access type and the new access type needs to be updated. The method also includes updating the UE count for the at least one of the old access type and the new access type by decreasing the UE count for the old access type, and keeping the UE count for the new access type unchanged. Further, the method includes adding a network function for the network function in a list of network functions that are in association with the network function ID of the other network function.

In yet another non-limiting embodiment of the present disclosure, upon determining that the other session over the new access type in association with other network function is available and the other session over the old access type is available, the method includes determining that the UE count needs to be kept unchanged for both the new access type and old access type, keeping the UE count for both the new access type and old access type unchanged, and adding a network function network function (NF) ID for the network function in a list of network functions in association with a network function ID of the other network function.

In yet another non-limiting embodiment of the present disclosure, for determining whether to update the UE count for at least one of the old access type and the new access type based on the update request, the method further includes determining whether a NSACF quota is available for the new access type, and updating the UE count for the at least one of the old access type and the new access type based on determining that the NSACF quota is available for the new access type.

In yet another non-limiting embodiment of the present disclosure, an apparatus to handle network slice admission control is disclosed. The apparatus comprises a processor. The apparatus also comprises a memory communicatively coupled to the processor, wherein the processor is configured to receive, at a network function session transfer request message from a user equipment (UE) for transferring a session from old access type to a new access type, and send, by the network function, update request having an update attribute to a Network Slice Admission Control Function (NSACF) for informing the NSACF about the new access type of the UE to provide the network slice admission control for a maximum number of registered UEs with at least one session.

In another non-limiting embodiment of the present disclosure, the network function comprises one of a Session Management Function (SMF) and Session Management Function Plus Packet data Unit Gateway (SMF+PGW−C).

In another non-limiting embodiment of the present disclosure, the session comprises one of PDU session and PDN connection.

In yet another non-limiting embodiment of the present disclosure, the old access type and the new access type are selected from a group of: 3GPP access type and non-3GPP access type, where the old access type and the new access type are different.

In yet another non-limiting embodiment of the present disclosure, the update request is a Nnsacf_NSAC_NumOfUEsUpdate request.

In yet another non-limiting embodiment of the present disclosure, an apparatus to handle network slice admission control is disclosed. The apparatus comprises a processor. The apparatus also comprises a memory communicatively coupled to the processor. The processor is configured to receive, at a Network Slice Admission Control Function (NSACF), update request from a network function. The update request includes an update attribute with information pertaining to a new access type of a user equipment (UE) which is already in a session over an old access type. The processor is configured to replace the old access type of the session with the new access type, determine whether to update UE count for at least one of the old access type and the new access type based on the update request, and update the UE count for the at least one of the old access type and the new access type based on the determining that the UE count needs to be updated for providing the network slice admission control.

In another non-limiting embodiment of the present disclosure, the network function comprises one of a Session Management Function (SMF) and Session Management Function Plus Packet data Unit Gateway (SMF+PGW−C).

In another non-limiting embodiment of the present disclosure, the session comprises one of PDU session and PDN connection.

In yet another non-limiting embodiment of the present disclosure, the update request is received from the network function in response to triggering of a transfer of the session from the old access type to the new access type.

In yet another non-limiting embodiment of the present disclosure, to determine whether to update the UE count for the at least one of the old access type and the new access type based on the update request, the apparatus is configured to determine whether there is an UE entry available in both new access type and old access type with the NSACF.

In yet another non-limiting embodiment of the present disclosure, upon determining availability of UE entry in the old access type with only same or associated network function ID and unavailability of UE entry in the new access type, the apparatus is configured to determine that the UE count for the at least one of the old access type and the new access type needs to be updated. The apparatus further updates the UE count for the at least one of the old access type and the new access type by decrease the UE count for the old access type, and removes the UE entry, and increase the UE count for the new access type by creating an UE entry.

In yet another non-limiting embodiment of the present disclosure, upon determining availability of UE entry in the old access type with same or associated network function (NF) ID along with more network function IDs, the apparatus is configured to determine that the UE count for the at least one of the old access type and the new access type needs to be updated, and update the UE count for the old access type by keeping the UE count for the old access type unchanged and remove network function ID.

In yet another non-limiting embodiment of the present disclosure, upon determining availability of UE entry in the new access type with more network function IDs, the apparatus configured to determine that the UE count for the at least one of the old access type and the new access type needs to be updated. The method may also comprise update the UE count for the new access type by keep the UE count for the new access type unchanged and adding the network function ID.

In yet another non-limiting embodiment of the present disclosure, upon determining that availability of UE entry in both old access type and new access type, the apparatus is configured to determine that the UE count needs to be kept unchanged for both the new access type and old access type, and keep the UE count for both the new access type and old access type unchanged and deleting network function network function ID from old access type and adding network function ID in the new access type.

In yet another non-limiting embodiment of the present disclosure, upon determining that the other session over the new access type in association with the other network function is available and the other session over the new access type is unavailable, the apparatus is configured to determine that the UE count for the at least one of the old access type and the new access type needs to be updated. The apparatus further updates the UE count for the at least one of the old access type and the new access type by decrease the UE count for the old access type, and keep the UE count for the new access type unchanged. The apparatus further adds a network function ID for the network function in a list of network functions in association with the network function ID of the other network function.

In yet another non-limiting embodiment of the present disclosure, upon determining that the other session over the new access type in association with other network function is available and the other session over the old access type is available, the apparatus is configured to determine that the UE count needs to be kept unchanged for both the new access type and old access type, keep the UE count for both the new access type and old access type unchanged, and add a network function ID for the network function in a list of network functions in association with a network function of the other network function.

In yet another non-limiting embodiment of the present disclosure, to determine whether to update the UE count for at least one of the old access type and the new access type based on the update request, the apparatus is further configured to determine whether a NSACF quota is available for the new access type, and update the UE count for the at least one of the old access type and the new access type based on determining that the NSACF quota is available for the new access type. Other technical features may be readily apparent to one skilled in the art from the following figures, descriptions, and claims.

Other technical features may be readily apparent to one skilled in the art from the following figures, descriptions, and claims.

The foregoing summary is illustrative only and is not intended to be in any way limiting. In addition to the illustrative aspects, embodiments, and features described above, further aspects, embodiments, and features will become apparent by reference to the drawings and the following detailed description.

### Advantageous Effects of Invention

The present disclosure provides an effective and efficient method for handling network slice admission control.

Advantageous effects obtainable from the disclosure may not be limited to the above mentioned effects, and other effects which are not mentioned may be clearly understood, through the following descriptions, by those skilled in the art to which the disclosure pertains.

### BRIEF DESCRIPTION OF DRAWINGS

The embodiments of the disclosure itself, as well as a preferred mode of use, further objectives, and advantages thereof, will best be understood by reference to the following detailed description of an illustrative embodiment when read in conjunction with the accompanying drawings. One or more embodiments are now described, by way of example only, with reference to the accompanying drawings in which:

FIG. 1 illustrates an exemplary environment 100 for handling network slice admission control in a communication network, in accordance with one embodiment.

FIG. 2 illustrates a line diagram depicting a method of transferring the PDU session from the non-3GPP AT to the 3GPP AT in accordance with the existing mechanism.

FIG. 3 illustrates a line diagram depicting a method of transferring the PDU session from the non-3GPP AT to the 3GPP AT in accordance with one embodiment

FIG. 4 illustrates a block diagram of a Session Management Function Plus Packet data Unit Gateway (SMF+PGW−C 102) to handle network slice admission control in accordance with one embodiment.

FIG. 5 illustrates a Network Slice Admission Control Function (NSACF) entity to handle network slice admission control in accordance with one embodiment.

FIG. 6 illustrates a method 600 for handling network slice admission control, in accordance with one embodiment.

FIG. 7 illustrates a method 700 method 600 for handling network slice admission control, in accordance with one embodiment.

It should be appreciated by those skilled in the art that any block diagrams herein represent conceptual views of the illustrative systems embodying the principles of the present subject matter. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### MODE FOR THE INVENTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the scope of the disclosure.

The terms “comprises,” “comprising”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises [symbol] a” does not, without more constraints, preclude the existence of other elements or additional elements in the system or apparatus.

In the following detailed description of the embodiments of the disclosure, reference is made to the accompanying drawings that form a part hereof, and in which are shown by way of illustration specific embodiments in which the description may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

The terms like “at least one” and “one or more” may be used interchangeably throughout the description. The terms like “a plurality of” and “multiple” may be used interchangeably throughout the description. The terms like “access type” and “AT” may be used interchangeably throughout the description. The terms like “existing access type” and “old access type” may be used interchangeably throughout the description. The terms like “network” and “communication network” may be used interchangeably throughout the description. The terms like “UE registration count”, “number of registered UEs” and “UE count” may be used interchangeably throughout the description.

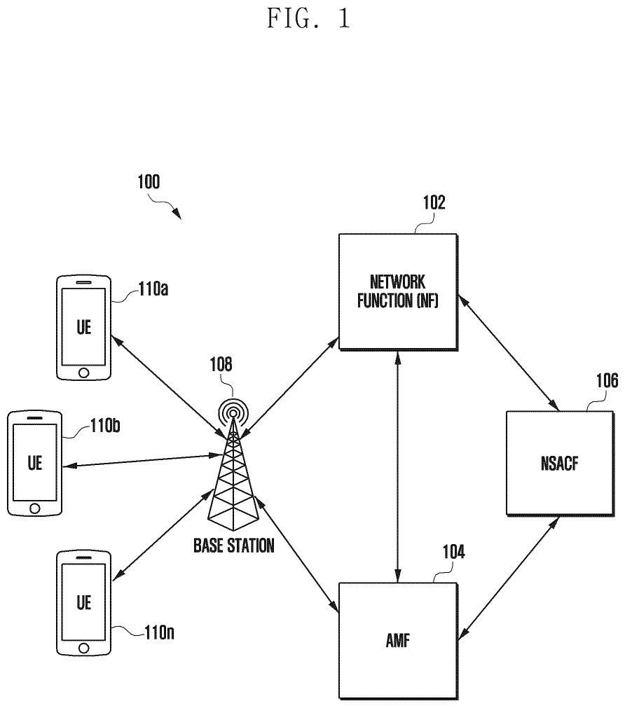

FIG. 1 shows an exemplary environment 100 for handling network slice admission control in a communication network. The present disclosure is applicable when the maximum Number of UEs limit applies to the UEs with at least one protocol data unit (PDU) session/packet data network (PDN) connection, and so the restriction criterion is uniform across the EPS and the 5GS. The environment 100 may include a network system comprising a network function which may include one of Session Management Function Plus Packet data Unit Gateway (SMF+PGW−C) entity 102 and Session Management Function (SMF) and an access and mobility function (AMF) entity 104 associated with a Base Station (BS) or a wireless network 108, a UE 110a, a UE 110b, UE 110n (herein after referred as plurality of UEs 110) and a Network Slice Admission Control Function (NSACF) entity 106. The plurality of UEs 110 may be connected to the base station or the wireless network 108 for communicating with each other. The plurality of UEs 110 may be any device used directly by an end-user for communication. The plurality of UEs 110 may include, but is not limited to, a mobile phone, a smart phone, and the like. In an embodiment, the base station (3GPP access)/the wireless network (non-3GPP access) 108 may serve as a central connection point for the plurality of UEs 110 for establishing communication. The base station 108 may be responsible for managing radio resources for cells, and for handling radio link protocols with the plurality of UEs 110. The base station 108 may also performs other functions such as mobility management, handover, authentication, and the like. Further, a network slice may be assigned to each of the plurality of UEs 110 for performing one or more applications. The one or more applications may include, but is not limited to, retail shipping application, gaming application, and the like. The network function 102 may be a control function that manages user sessions including establishment, modification, and release of sessions in a 5G network. Further, the AMF 104 may manage connection and mobility management of the plurality of UEs 110 while forwarding session management requirements to the network function 102. The NSACF 106 may manage count of the plurality of UEs 110 and the sessions for the network slice in the network system.

As discussed in previous paragraphs, when the UE 110 transfers a session such as protocol data unit (PDU) session from one existing/old) access type to another (new) access type, the network function 102 needs to ensure that the UE registration count is decreased for the non-3GPP AT and is increased for the 3GPP AT which may not be possible using the existing mechanism. In the present disclosure terms such as existing access type and old access type are interchangeably used.

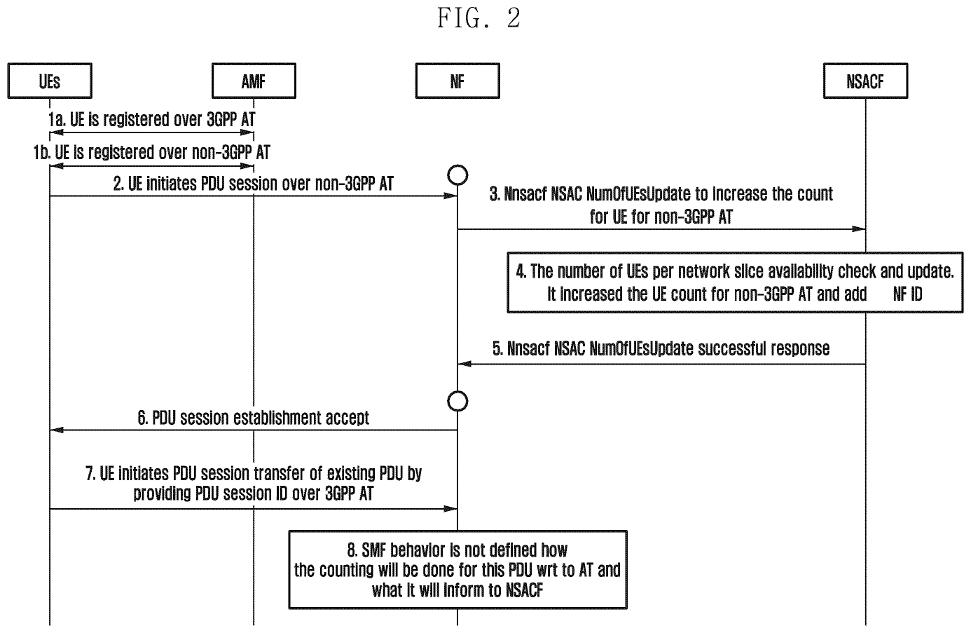

FIG. 2 illustrates a line diagram depicting a method of transferring a protocol data unit (PDU) session from non-3GPP AT to 3GPP AT in accordance with the existing mechanism. Considering that one UE 110 is registered over 3GPP access type (AT) and non-3GPP AT as shown at steps 1a and 1b. Later, the UE may initiate a PDU session over non-3GPP AT and the request may be received by the network function. The network function may include one of Session Management Function Plus Packet data Unit Gateway (SMF+PGW−C) entity 102 and Session Management Function (SMF). For instance, when the UE may initiate a session (such as PDU session or PDN connection) over non-3GPP AT and the request may be received by the network function 102, as shown at step 2. Upon receipt of the request, the network function 102 may inform the NSACF 106 to increase a count for number of registered UEs and number of concurrent PDU sessions using existing service operation Nnsacf_NSAC_NumOfUEsUpdate and Nnsacf_NSAC_NumOfPDUsUpdate upon the PDU session request, at shown at step 3. Thereafter, the NSACF 106 may determine that this is the first PDU session for the UE 110 over the non-3GPP AT and the quota is available. Hence, the NSACF 106 may increase the count for non-3GPP AT and add an entry with UE identifier (ID) and network function ID, as shown at step 4. Thereafter, the NSACF 106 may send a successful response to the network function 102 upon updating the entry at step 5. Thereafter, the PDU session may be established over the non-3GPP AT and the network function 102 may inform the same to the UE 110, as shown by step 6.

In the existing technology, when the UE 110 want to move the PDU session from the non-3GPP AT to the 3GPP AT, the UE 110 may initiate a session establishment which include one of PDU session and PDN connection. In an embodiment, the UE 110 may initiate PDU session establishment by giving the established PDU session ID of the non-3GPP AT in sequence with the PDU session establishment, as shown by step 7. The network function 102 may receive the PDU session transfer request from the UE 110. However, the behavior of network function 102 is undefined on how to perform the counting of the number of registered UEs towards the NSACF 106, which may lead to a wrong counting information at the NSACF 106 and failing the NSAC feature as a whole. However, the problem is not limited to this method only. It may be possible through allowed PDU session status IE or some other possible mechanism as well. Also, the problem is not restricted to the PDU transfer from the non-3GPP AT to the 3GPP AT, but also possible for the 3GPP AT to the non-3GPP AT, but not limited thereto. The problem covers all kinds of PDU session transfer between AT over 5GS or EPC IWK as well.

The present disclosure discloses the techniques to enable the transfer of the PDU session from one access type to another access type to efficiently handle the network slice admission control in a communication network. In an embodiment, when a UE with a PDU session over an access type sends a request for the transfer of the PDU session from the one access type to the other access type, the network function 102 may receive the request and may send update requests to the NSACF 106 to inform the NSACF 106 about the new access type of the access type. The NSACF 106 may process the received update request to provide the network slice admission control for maximum number of registered UEs with at least one PDU Session/PDN connection. The method, device and system disclosed herein describe how the NSACF 106 does the counting for the number of registered UEs when PDU session transfers happen in the network system with the new updated information received from the network function 102.

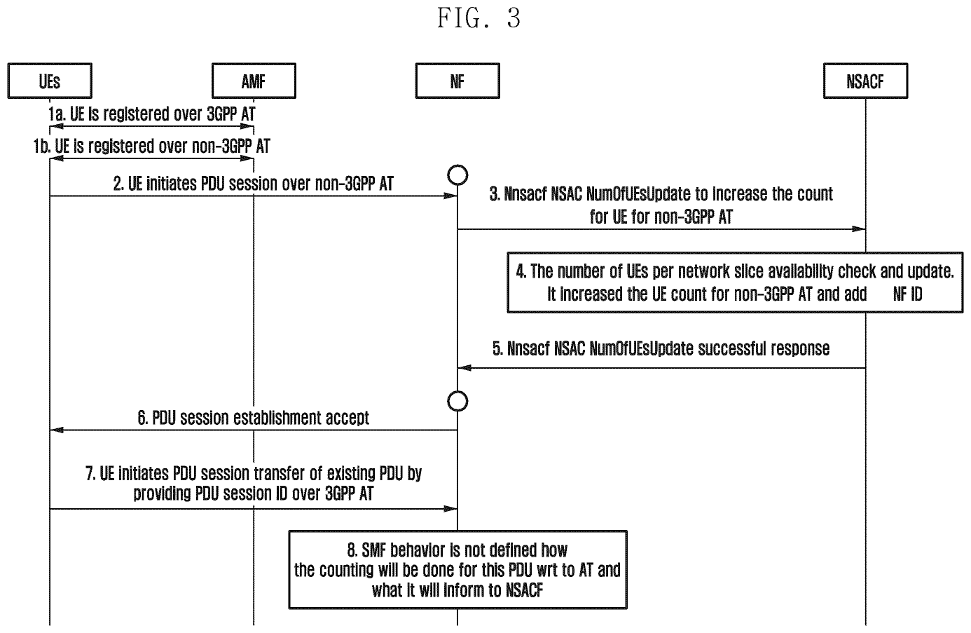

FIG. 3 illustrates a line diagram depicting a method of transferring the PDU session from the non-3GPP AT to the 3GPP AT in accordance with operations that is expected to take place in a typical network deployment where slice admission control features are enabled in a communication network, according to one or more embodiments of the present disclosure. In a 5G network, consider one UE 110 is registered over 3GPP AT and non-3GPP AT as shown at step 1a and 1b. In the next step 2, the UE may initiate one PDU session over non-3GPP access and the request is landed at network function 102. Further, network function 102 comprises one of SMF and SMF+PGW−C may inform the NSACF 106 to increase the count for number of registered UEs and number of concurrent PDU sessions using existing service operation Nnsacf_NSAC_NumOfUEsUpdate and Nnsacf_NSAC_NumOfPDUsUpdate, at step 3. As the issue is about the number of registered UEs, the illustrated flow is focused with respect to the NSACF behavior around that counting. The number of concurrent PDU sessions may behave as per the existing solution.

Further, the NSACF 106 may observe that this is the first PDU session for the UE over non-3GPP access and the quota is available. Hence, it may increase the count for non-3GPP AT and add entry with UE ID and network function ID upon the reception of PDU session request, as shown at step 4. Then, the NSACF 106 may send successful response to network function at step 5. Later, the PDU session is established over the non-3GPP AT, at step 6. As a next event in the sequence, the UE may now wish to move the PDU session from the non-3GPP AT to the 3GPP AT and hence initiates a PDU session establishment by giving the established PDU session ID of the non-3GPP AT, at step 7. Later, the request is landed at the network function, and the present disclosure discloses that the network function comprises one of SMF and SMF+PGW−C sends Nnsacf_NSAC_NumOfUEsUpdate service operation message with 3GPP AT and update flag set to “update” at step 8.

Further, when the NSACF 106 receives Nnsacf_NSAC_NumOfUEsUpdate service operation message with update flag set to “update” then, it replaces the AT of the UE registration with the new AT, at step 9. It means, when PDU session is transferred from non-3GPP to 3GPP, the network function may provide AT as 3GPP. Here, the NSACF 106 may replace the existing non-3GPP AT (which would have been added during initial PDU session established over non-3GPP AT) with new AT which is 3GPP. With this, the NSACF 106 may decrease the count from non-3GPP AT and increase the count for 3GPP AT. In this case, the assumption is that NSACF 106 did not find any UE ID entry for 3GPP AT (as there was no PDU session from UE over 3GPP AT either with this network function or another network function).

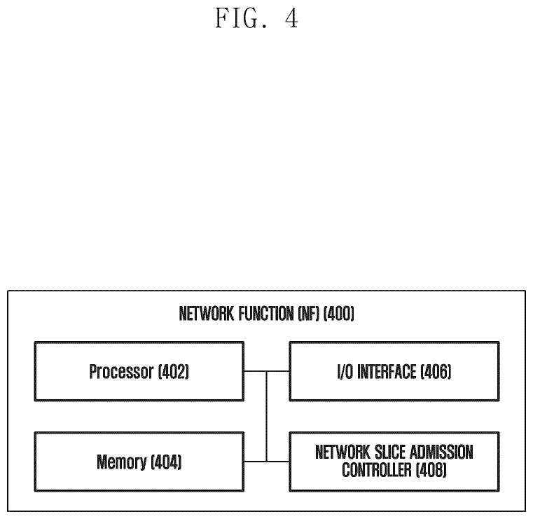

FIG. 4 illustrates a block diagram of a network function 400 to handle network slice admission control in accordance with various embodiments of the present disclosure. The network function 400 may comprise various hardware components such as a processor 402, a Memory 404, an I/O interface 406, and a Network Slice Admission Controller 408, but not limited thereto. The processor 402, the memory 404, the I/O interface 406, and the Network Slice Admission Controller 408 may be communicatively coupled to each other via wired or wireless communication channels. In an embodiment, the operation of the Network Slice Admission Controllers 408 may be performed by the processor 402. The Network Slice Admission Controller 408 may be physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor 402 may be configured to execute instructions stored in the memory 404 and to perform various processes. The I/O interface 406 may be configured for coupling the internal hardware components and with external devices via one or more networks. The memory 404 may also store instructions to be executed by the processor 402. The memory 404 may include a Random-Access Memory (RAM) unit and/or a non-volatile memory unit such as a Read Only Memory (ROM), optical disc drive, magnetic disc drive, flash memory, Electrically Erasable Read Only Memory (EEPROM), a memory space on a server or cloud and so forth. The Memory 404 may also store data processed by the processor 402 and the Network Slice Admission Controller 408 and obtained via I/O interface 406.

According to an embodiment, when the UE 110 sends a request to transfer the PDU session from an existing/old access type to a new access type, the request sent by the UE 110 may be received at the network function 400. The Network Slice Admission Controller 408 of the network function 400 may receive the UE's request via the I/O interface 406. The existing access type may also be referred as an old access type. The terms “existing access type” and the “old access type” are used interchangeably throughout the present disclosure. The existing access type and the new access type are different and may be selected from a group of: 3GPP access type (AT) and non-3GPP AT. The request received from the UE 110 is a protocol data unit (PDU) session transfer request message from the UE 110 for transferring the PDU session from the existing to the new access type. The received request may be processed by the Network Slice Admission Controller 408 and in response to receiving the request message, the Network Slice Admission Controller 408 may send an update request to the NSACF 106. The update request may comprise an update attribute to inform the NSACF 106 about the new access type of the UE. The update request is a Nnsacf_NSAC_NumOfUEsUpdate request. The update request received from the network function enables the NSACF to provide the network slice admission control for a maximum number of registered UEs with at least one PDU Session/PDN connection.

In an embodiment of the present disclosure, when the network function 400 receives the PDU session transfer from the non-3GPP AT to the 3GPP AT or vice-versa with the slice which is subject to NSAC, then the network function may inform the NSACF 106 with an update flag set to a new attribute “update” instead of “increase” or “decrease” in Nnsacf_NSAC_NumOfUEsUpdate service operation message.

Although FIG. 4 shows various hardware components of the network function 400 but it is to be understood that other embodiments are not limited thereon. In other embodiments, the network function 400 may include a lesser or greater number of components. Further, the labels or names of the components are used only for illustrative purpose and does not limit the scope of the disclosure. One or more components can be combined together to perform same or substantially similar function in the network function 400.

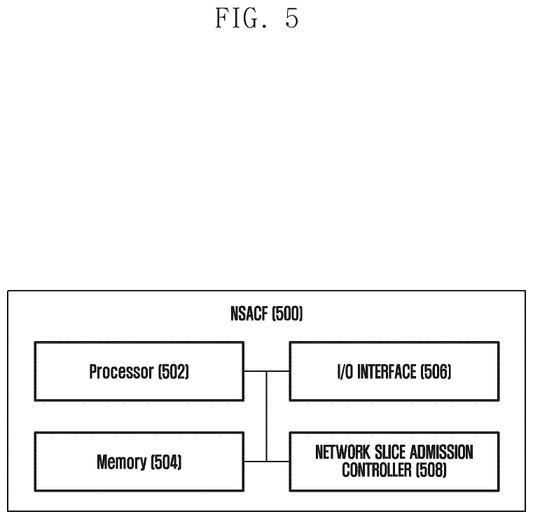

FIG. 5 illustrates a block diagram of a Network Slice Admission Control Function (NSACF) entity 500 to handle network slice admission control in accordance with various embodiments of the present disclosure. The NSACF 500 may comprise various hardware components such as a processor 502, a Memory 504, I/o interface 506 and Network Slice Admission Controller 508, but not limited thereto. The processor 502, the memory 504, the I/O interface 506, and the Network Slice Admission Controller 508 may be communicatively coupled to each other via wired or wireless communication channels. In an embodiment, the operation of the Network Slice Admission Controllers 508 may be performed by the processor 502. The Network Slice Admission Controller 508 may be physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor 502 may be configured to execute instructions stored in the memory 504 and to perform various processes. The I/o interface 506 may be configured for coupling the internal hardware components and with external devices via one or more networks. The memory 504 may also stores instructions to be executed by the processor 502. The memory 504 may include a Random-Access Memory (RAM) unit and/or a non-volatile memory unit such as a Read Only Memory (ROM), optical disc drive, magnetic disc drive, flash memory, Electrically Erasable Read Only Memory (EEPROM), a memory space on a server or cloud and so forth. The memory 504 may also store data processed by the processor 502 and the Network Slice Admission Controller 508 and obtained via I/O interface 506.

According to an embodiment, in response to the triggering of a transfer of a PDU session from an existing access type to a new access type, the NSACF 500 may receive an update request from the network function 400. The Network Slice Admission Controller 508 of the NSACF 500 may receive the update request from the network function 400 via the I/o interface 506. The update request may comprise an update attribute with information pertaining to the new access type of the UE 110 which is already in the PDU session over the existing access type. Upon receiving the update request, the Network Slice Admission Controller 508 may determine whether a NSACF quota is available for the new access type. If the quota is available for the new access type, the Network Slice Admission Controller 508 may replace the existing access type of the PDU session with the new access type. Further, the Network Slice Admission Controller 508 may determine whether to update the UE count for at least one of the existing access types and the new access type based on the update request. In order to determine whether to update the UE count, the Network Slice Admission Controller 508 may determine whether there is a UE entry available in at least one of the new access types and the existing access type with the NSACF 500. Particularly, the Network Slice Admission Controller 508 may determine the availability of the UE entry in at least one of the new access types and the existing access type in association with the same network function or other network functions. In an embodiment of the present disclosure, the NSACF 500 may update the UE count for the at least one of the existing access types and the new access type based on determining that the NSACF quota is available for the new access type.

In an embodiment of the present disclosure, the Network Slice Admission Controller 508 may determine that the UE entry is available in the existing access type with only same or associated network function ID and the UE entry is unavailable in the new access type. Upon determining availability of UE entry in the existing access type with only same or associated network function ID and unavailability of UE entry in the new access type, the Network Slice Admission Controller 508 may determine that the UE count for the at least one of the existing access types and the new access type needs to be updated. The Network Slice Admission Controller 508 may update the UE count by decreasing the UE count for the existing access type and removing the UE entry and by increasing the UE count for the new access type by creating a UE entry for the new access type.

In another embodiment of the present disclosure, the Network Slice Admission Controller 508 may determine that the UE entry is available in the existing access type with same or associated network function (NF) ID along with more NF IDs. Upon determination, the Network Slice Admission Controller 508 may determine that the UE count for the at least one of the existing access types and the new access type needs to be updated. The Network Slice Admission Controller 508 may update the UE count for the existing access type by keeping the UE count for the existing access type unchanged and remove the associated NF ID.

In another embodiment of the present disclosure, the Network Slice Admission Controller 508 may determine that the UE entry is available in the new access type with more NF IDs. Upon determination, the Network Slice Admission Controller 508 may determine that the UE count for at least one of the existing access types and the new access type needs to be updated. Thereafter, the Network Slice Admission Controller 508 of the NSACF 500 may update the UE count for the new access type by keeping the UE count for the new access type unchanged and adding the network function ID.

in another embodiment of the present disclosure, the Network Slice Admission Controller 508 may determine that the UE entry is available in both existing access type and new access type. Upon determination, the Network Slice Admission Controller 508 may determine that the UE count needs to be kept unchanged for both the new access type and existing access type. The Network Slice Admission Controller 508 may keep the UE count for both the new access type and existing access type unchanged. The Network Slice Admission Controller 508 may delete network function ID from existing access type and add network function ID in the new access type.

In another embodiment of the present disclosure, the Network Slice Admission Controller 508 may determine that the other PDU session over the new access type in association with the other network function is available and the other PDU session over the new access type is unavailable. Upon determination, the Network Slice Admission Controller 508 may further determine that the UE count for at least one of the existing access types and the new access type needs to be updated. The Network Slice Admission Controller 508 of the NSACF 500 may update the UE count for the at least one of the existing access types and the new access type by: decreasing the UE count for the existing access type and keeping the UE count for the new access type unchanged. The Network Slice Admission Controller 508 may also add a network function ID for the network function in a list of network functions in association with the network function ID of the other network function. In the present disclosure terms such as some PDU session or other PDU session and the term like different network function or other network function are interchangeably used.

In another embodiment of the present disclosure, the Network Slice Admission Controller 508 may determine that the other PDU session over the new access type in association with other network function is available and the other PDU session over the existing access type is also available. Upon determination, the Network Slice Admission Controller 508 of the NSACF 500 may determine that the UE count needs to be kept unchanged for both the new access type and existing access type. Thus, the Network Slice Admission Controller 508 may keep the UE count for both the new access type and existing access type unchanged. Further, the Network Slice Admission Controller 508 may add network function ID for the network function in a list of network function in association with a network function ID of the other network function.

For example, the NSACF 106 may receive Nnsacf_NSAC_NumOfUEsUpdate service operation message with update flag set to “update”. Upon receiving, the NSACF 106 may replace the access type of the UE 110 registration with the new access type. For example, when a PDU session is transferred from the non-3GPP AT to the 3GPP AT then network function 102 may provide the access type as the 3GPP AT. For example, the NSACF 106 may replace the existing non-3GPP AT (which would have been added during the initial PDU session established over the non-3GPP AT) with the new AT which may be the 3GPP AT. With this, the NSACF 106 may decrease the count from the non-3GPP AT and increase the count for the 3GPP AT. In this case, the assumption is that the NSACF 106 did not find any UE ID entry for the 3GPP AT (as there was no PDU session from UE over 3GPP AT either with this network function or another network function).

In another example, when the NSACF receives Nnsacf_NSAC_NumOfUEsUpdate service operation message with the update flag set to “update” and the NSACF determines that already one UE ID entry with the 3GPP AT with same network function ID is already present (if the UE had created another PDU session over the 3GPP AT then based on the request from the network function, the NSACF may have added a UE ID entry with this network function ID for the 3GPP AT) then the NSACF may not increase the count again for the 3GPP AT but simply remove the non-3GPP AT entry and decrease the count, if this was the only PDU session in the non-3GPP AT and no more PDU session is left for the non-3GPP AT for the UE with either this network function or another network function as well.

In yet another example, when the NSACF receives the Nnsacf_NSAC_NumOfUEsUpdate service operation message with update flag set to “update” and the NSACF determines that already one UE ID entry with the 3GPP AT with different network function ID is already present (if the UE had created another PDU session over the 3GPP AT then based on the request from another network function, the NSACF may have added a UE ID entry with another network function ID for the 3GPP AT), then the NSACF may not increase the count again for the 3GPP AT, add this new network function ID entry AT to the already present another network function ID and remove the non-3GPP AT entry and decrease the count if this was the only PDU session in the non-3GPP AT and no more PDU session is left for the non-3GPP AT for this UE with either this network function or another network function as well.

In yet another example, when the NSACF receives the Nnsacf_NSAC_NumOfUEsUpdate service operation message with the update flag set to “update” and the NSACF quota is not available for the 3GPP AT, when NSAC is applicable for the 3GPP AT only, then the NSACF may reject the request and inform the network function. There may not be any existing entry of the UE ID for the non-3GPP AT, when the NSAC is only applicable for the 3GPP AT and the NSACF may have accepted the request from the network function over the non-3GPP AT without creating any entry at the NSACF.

In an embodiment of the present disclosure, when the network slice admission control is performed in the Evolved Packet System (EPS), a network function such as session management function plus packet data network gateway control plane function (SMF+PGW−C) or SMF may trigger the request and the Network Slice Admission Control for maximum number of registered UEs is performed at the time of packet data network (PDN) connection.

In this manner, the present disclosure ensures that the 5G system is able to accurately enforce quota on the maximum number of registered UEs using a network slice defined by an S-NSSAI.

Although FIG. 5 shows various hardware components of the NSACF 500, but it is to be understood that other embodiments are not limited thereon. In other embodiments, the NSACF 500 may include a lesser or greater number of components. Further, the labels or names of the components are used only for illustrative purposes and does not limit the scope of the disclosure. One or more components can be combined together to perform same or substantially similar function in the NSACF 500.

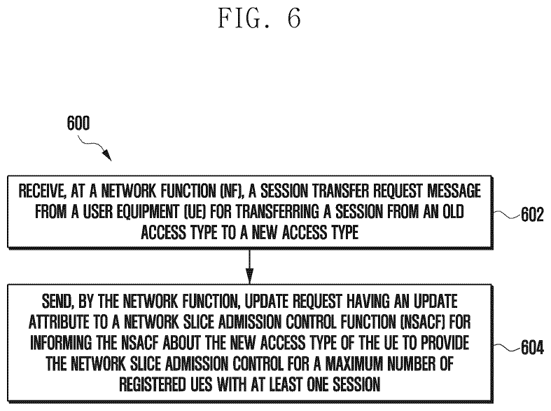

FIG. 6 illustrates a method 600 for handling network slice admission control, in accordance with an embodiment of the present disclosure. Although example method 600 depicts a particular sequence of operations, the sequence may be altered without departing from the scope of the present disclosure. For example, some of the operations depicted may be performed in parallel or in a different sequence that does not materially affect the function of the method 600. In other examples, different components of the network functions such as SMF+PGW−C 400 or SMF implement the method 600 and may perform functions at substantially the same time or in a specific sequence.

According to some examples, the method 600 includes receiving, at a network function, session transfer request message from a user equipment (UE) for transferring a session such as PDU session or PDN connection from an existing or old access type to a new access type at block 602. The network function may include one of SMF and SMF+PGW−C. The existing or old access type and the new access type may be different and may be selected from a group of: 3GPP access type and non-3GPP access type. The method 600 further at block 604 recites sending, by the network function, update request having an update attribute to a Network Slice Admission Control Function (NSACF) for informing the NSACF about the new access type of the UE to provide the network slice admission control for a maximum number of registered UEs with at least one session such as PDU session and PDN connection. In an embodiment of the present disclosure, the update request is a Nnsacf_NSAC_NumOfUEsUpdate request, but not limited thereto.

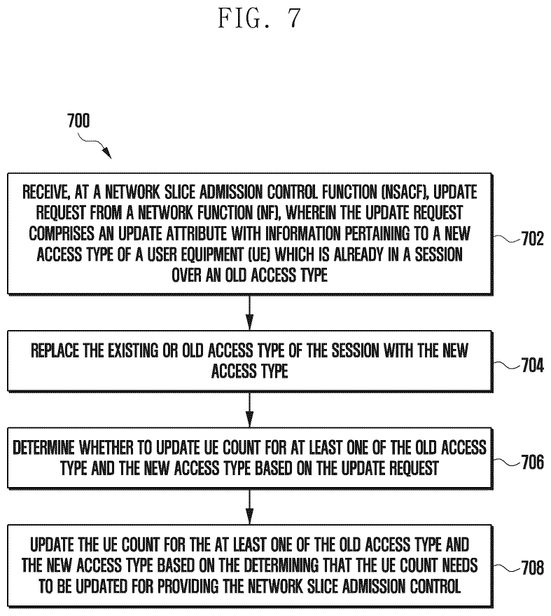

FIG. 7 illustrates an example method 700 of handling network slice admission control in accordance with an embodiment of the present disclosure. Although the example method 700 depicts a particular sequence of operations, the sequence may be altered without departing from the scope of the present disclosure. For example, some of the operations depicted may be performed in parallel or in a different sequence that does not materially affect the function of the method 700. In other examples, different components of the NSACF 500 may implement the method 700 and may perform functions at substantially the same time or in a specific sequence. The methods disclosed herein describe how the NSACF does the counting for the number of registered UEs when PDU session transfers happen in the system with the new updated information received from the network function.

According to some examples, at block 702, method 700 receives, at the NSACF, update request from the network function. The update request comprises an update attribute with information pertaining to a new access type of a user equipment (UE) which is already in a session over an old access type. The update request may be received from the network function in response to triggering a transfer of the session from the existing access type to the new access type.

In block 704, method 700 replaces the existing or old access type of the PDU session with the new access type. In block 706, method 700 determines whether to update UE count for at least one of the existing or old access type and the new access type based on the update request. In an embodiment of the present disclosure, determining whether to update the UE count for at least one of the existing access type and the new access type based on the update request further comprises: determining whether a NSACF quota is available for the new access type and updating the UE count for the at least one of the existing access type and the new access type based on determining that the NSACF quota is available for the new access type. In another embodiment, determining whether to update the UE count for the at least one of the existing access types and the new access type based on the update request comprises determining whether there is a UE entry available in both new access type and old access type with the NSACF.

According to an embodiment of the present disclosure, upon determining availability of UE entry in the existing access type with only same or associated network function ID and unavailability of UE entry in the new access type, the method 700 recites determining that the UE count for the at least one of the existing or old access type and the new access type needs to be updated and updating the UE count for the at least one of the existing or old access type and the new access type. The method 700 comprises updating the UE count by decreasing the UE count for the existing or old access type, and removing the UE entry, and by increasing the UE count for the new access type by creating a UE entry.

In another embodiment of the present disclosure, upon determining availability of UE entry in the existing or old access type with same or associated network function (NF) ID along with more NF IDs, the method 700 recites determining that the UE count for the at least one of the existing access type and the new access type needs to be updated and updating the UE count for the existing or old access type by keeping the UE count for the existing access type unchanged and remove NF ID.

In another embodiment of the present disclosure, upon determining the availability of UE entry in the new access type with more network function (NF) IDs, the method 700 recites determining that the UE count for the at least one of the existing or old access type and the new access type needs to be updated and updating the UE count for the new access type. The updating of the UE count comprises keeping the UE count for the new access type unchanged and adding the network function ID.

In another embodiment of the present disclosure, upon determining the availability of UE entry in both existing or old access type and new access type, the method 700 recites determining that the UE count needs to be kept unchanged for both the new access type and existing or old access type, keeping the UE count for both the new access type and existing access type unchanged and deleting network function ID from existing or old access type and adding network function ID in the new access type.

In another embodiment of the present disclosure, upon determining that the other PDU session over the new access type in association with the other network function is available and the other PDU session over the new access type is unavailable, the method 700 recites determining that the UE count for the at least one of the existing or old access type and the new access type needs to be updated. The method 700 updates the UE count for the at least one of the existing or old access type and the new access type by: decreasing the UE count for the existing or old access type, keeping the UE count for the new access type unchanged; and adding a network function ID for the network function in a list of network functions in association with the network function ID of the other network function.

In another embodiment of the present disclosure, upon determining that the other PDU session over the new access type in association with other network function is available and the other PDU session over the existing or old access type is available, the method 700 recites determining that the UE count needs to be kept unchanged for both the new access type and existing or old access type. Thereafter, the method 700 recites keeping the UE count for both the new access type and existing or old access type unchanged and adding a network function ID for the network function in a list of network functions in association with a network function ID of the other network function.

In block 708, method 700 recites updating the UE count for the at least one of the existing or old access type and the new access type based on the determining that the UE count needs to be updated for providing the network slice admission control.

In this manner, the present disclosure ensures that the 5G system is able to accurately enforce quota on the maximum number of registered UEs using a network slice defined by an S-NSSAI.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the detailed description.

The order in which the various operations of the methods are described is not intended to be construed as a limitation, and any number of the described method blocks can be combined in any order to implement the method. Additionally, in-dividual blocks may be deleted from the methods without departing from the spirit and scope of the subject matter described herein. Furthermore, the methods can be implemented in any suitable hardware, software, firmware, or combination thereof.

It may be noted here that the subject matter of some or all embodiments described with reference to FIGS. 1-7 may be relevant for the methods and the same is not repeated for the sake of brevity.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in Figures, those operations may be performed by any suitable corresponding counterpart means-plus-function components.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

Certain aspects may comprise a computer program product for performing the operations presented herein. For example, such a computer program product may comprise a computer readable media having instructions stored (and/or encoded) thereon, the instructions being executable by one or more processors to perform the operations described herein. For certain aspects, the computer program product may include packaging material.

Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

As used herein, a phrase referring to “at least one” or “one or more” of a list of items refers to any combination of those items, including single members. As an example, “at least one of: a, b, or c” is intended to cover: a, b, c, a-b, a-c, b-c, and a-b-c. The terms “a”, “an” and “the” mean “one or more”, unless expressly specified otherwise.

The terms “including”, “comprising”, “having” and variations thereof, when used in a claim, is used in a non-exclusive sense that is not intended to exclude the presence of other elements or steps in a claimed structure or method, unless expressly specified otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present disclosure are intended to be illustrative, but not limiting, of the scope of the invention, which is set forth in the appended claims.

### LISTING OF DRAWING ELEMENTS

100 Environment
102, 400 network function
104 AMF
106, 500 NSACF
108 Base Station
110a-n UE
402, 502 Processor
404, 504 Memory
406, 506 I/O interface
408, 508 Network Slice Admission Controller
600, 700 Method

1. A method performed by a network slice admission control function (NSACF) in a communication system, the method comprising:
receiving, from a session management function plus packet data network gateway control plane function (SMF+PGW−C), a message for controlling a number of user equipment (UEs) registered to a network slice, the message comprising an update flag;
identifying whether the update flag comprises update value indicating that an access type of the UE is to be replaced with a new access type; and
in case that the update flag comprises the update value, replacing the access type of the UE with the new access type.

2. The method of claim 1, wherein the message further comprises at least one of a UE identifier (ID), or an identity of SMF+PGW−C.

3. The method of claim 1, further comprising:
in case that there was one UE entry in the new access type with same network function (NF) identifier (ID), keeping a count associated with the number of the UEs not increased.

4. The method of claim 1, further comprising:
in case that there was one UE entry in the new access type with different network function (NF) identifier (ID), adding a new NF ID, and keeping a count associated with the number of the UEs not increased.

5. A method performed by a session management function plus packet data network gateway control plane function (SMF+PGW−C) in a communication system, the method comprising:
receiving, from a user equipment, a packet data unit (PDU) session establishment request;
transmitting, to a network slice admission control function (NSACF), a first message for controlling a number of user equipment (UEs) registered to a network slice, the first message comprising an update flag; and
as a response to the first message, receiving, from the NSACF, a second message associated with update result.

6. The method of claim 5,
wherein the first message further comprises at least one of a UE identifier (ID), or an identity of SMF+PGW−C.

7. The method of claim 5,
wherein the update flag comprises an update value indicating that an access type of the UE is to be replaced with a new access type.

8. A network slice admission control function (NSACF) in a communication system, the NSACF comprising:
a transceiver; and
at least one processor coupled with the transceiver and configured to:
receive, from a session management function plus packet data network gateway control plane function (SMF+PGW−C), a message for controlling a number of user equipment (UEs) registered to a network slice, the message comprising an update flag,
identify whether the update flag comprises update value indicating that an access type of the UE is to be replaced with a new access type, and in case that the update flag comprises the update value, replace the access type of the UE with the new access type.

9. The NSACF of claim 8,
wherein the message further comprises at least one of a UE identifier (ID), or an identity of SMF+PGW−C.

10. The NSACF of claim 8, wherein the at least one processor is configured to:
in case that there was one UE entry in the new access type with same network function (NF) identifier (ID), keep a count associated with the number of the UEs not increased.

11. The NSACF of claim 8, wherein the at least one processor is configured to:
in case that there was one UE entry in the new access type with different network function (NF) identifier (ID), add a new NF ID, and keeping a count associated with the number of the UEs not increased.

12. A session management function plus packet data network gateway control plane function (SMF+PGW−C) in a communication system, the SMF+PGW−C comprising:
a transceiver; and
at least one processor coupled with the transceiver and configured to:
receive, from a user equipment, a packet data unit (PDU) session establishment request,
transmit, to a network slice admission control function (NSACF), a first message for controlling a number of user equipment (UEs) registered to a network slice, the first message comprising an update flag, and
as a response to the first message, receive, from the NSACF, a second message associated with update result.

13. The SMF+PGW−C of claim 12,
wherein the first message further comprises at least one of a UE identifier (ID), or an identity of SMF+PGW−C.

14. The SMF+PGW−C of claim 12,
wherein the update flag comprises an update value indicating that an access type of the UE is to be replaced with a new access type.
